(19) United States
(12) Patent Application Publication
(10) Pub. No.: US 2003/0002825 A1
(43) Pub. Date: Jan. 2, 2003

(54) Carrier sub-assembly with inserts and method for making the same

(76) Inventors: Jeffrey A. Karker, Cazenovia, NY (US); Kirankumar H. Dalal, N. Andover, MA (US); Norbert Adams, Syracuse, NY (US); Charles Mead, Newbury, MA (US); Juan L. Sepulveda, Tucson, AZ (US)

Correspondence Address: CALFEE HALTER & GRISWOLD, LLP, 800 SUPERIOR AVENUE, SUITE 1400, CLEVELAND, OH, 44114, US

(21) Appl. No.: 09/897,851

(22) Filed: Jul. 2, 2001

(51) Int. Cl. G02B 6/42

(52) U.S. Cl. 385/92; 385/88

(57) ABSTRACT

A carrier sub-assembly having improved dimensional stability for applications in electronic and optoelectronic industries is disclosed. The carrier sub-assembly, when housed in an optoelectronic package, for example, includes a metal substrate and an insert which support optoelectronic devices that are optically coupled to one another. The insert allows for the attachment, for example, via laser spot welding, of electronic and optoelectronic devices where direct attachment of a device to the metal substrate is not practical. In one embodiment of the present invention, the carrier sub-assembly includes Kovar™ insert that is attached to copper/tungsten metal substrate in a recess of the metal substrate so that at least a portion of the insert is attached to the metal substrate in three dimensions. A fiber optic assembly is secured to the insert by a Kovar™ clip. When the carrier sub-assembly is exposed to temperature excursions and thermal cycling, dimensional stability in the insert and metal substrate materials is maintained thereby yielding improved optical efficiency between the laser and the fiber optic assembly devices.

### FIELD OF THE INVENTION

The present invention relates generally to a carrier sub-assembly for use in the electronic and optoelectronic industries and the method for making the same. More specifically, the present invention relates a carrier sub-assembly having two or more material compositions and the method for making the same.

### BACKGROUND

Carrier sub-assemblies find wide use in the electronic, communications and information processing industries in electronic packages and optoelectronic packages, such as, for example, lasers, pump laser diodes, tunable lasers, amplifiers, receivers, transmitters, transceivers, etc. Carrier sub-assemblies typically contain various electronic and optoelectronic sources, detectors, modulators, etc., many of which generate heat. Accordingly, the carrier sub-assemblies are generally made of materials which are good electrical conductors and have high thermal conductivity (TC) so that there is high rate of heat transfer away from the heat-generating components. These materials also have thermal expansion properties that closely match the devices they house.

Optoelectronic packages, in particular, generate and harness light and other forms of radiant energy whose quantum unit is the photon. These packages house optoelectronic devices which emit, transmit or receive light or other optical radiation and which may function as an electrical-to-optical or optical-to-electrical transducer. A stringent requirement of the optoelectronic packages is that the alignment between the optoelectronic devices must be within submicron tolerances to prevent a measurable leakage of optical energy, or in other words, to achieve high optical coupling. For example, in a laser package, a light-emitting laser light source is optically aligned with an optical fiber that transmits light through the package.

The problem of misalignment of optoelectronic devices in a conventional optoelectronic package is more easily understood with reference to FIGS. 1(a) and 1(b). FIG. 1(a) shows optoelectronic package 10 which is a conventional laser package. The laser package has a housing 34 and a carrier sub-assembly that includes metal substrate 14, mounting plate 20, laser 12, photo detector 26, submount 16, fiber optic assembly 18 and alignment ware 22. The housing allows the passage of light through the laser package at 32 and in many cases provides a hermetic seal that protects the optoelectrical devices from the environment. Metal substrate 14 and mounting plate 20 support fiber optic assembly 18 so that it is optically coupled to laser 12 which is directly or indirectly mounted on the metal substrate. Alignment ware 22 attaches to the mounting plate to secure fiber optic assembly in place. The laser package shown also includes submount 16 which provides a raised platform for laser 12 and photo detector 26 so that laser 12 is optically coupled to the optic fiber contained within fiber optic assembly 18.

In many optoelectronic packages, alignment ware 22 and metal substrate 14 are made of dissimilar materials. Metal substrate 14, and submount 16 if present, generally have a high thermal conductivity to quickly dissipate the heat that is generated by the light source, laser 12. The metal substrate can be made of a single metal or a metallic alloy, but are more commonly made of a metal matrix composite (MMC) or a combination of clad metallic film layers, all of which have a high thermal conductivity. Alignment ware 22, however, is typically made of a metallic alloy, such as Kovar™ (Kovar is a trade name of materials comprising particular combinations of iron, nickel and cobalt, ASTM F-15), and cannot be directly attached to metal substrates that are made of, for example, metal matrix composites. Thus, mounting plate 20 is included in the carrier sub-assembly to provide a surface onto which the alignment ware can be attached, commonly via laser spot welding. The mounting plate is usually made of a material composition that has inferior heat dissipating properties compared to the metal substrate but one that provides for good laser spot welding.

Alignment problems between optoelectronic devices arise when a carrier sub-assembly and/or an optoelectronic package is subjected to temperature excursions during manufacturing operations. When mounting plate 20 is attached to metal substrate 14 they are brazed at temperatures ranging from room temperature to higher than 500° C. depending on the brazing compound that is used. The mounting plate and metal substrate, being dissimilar materials, expand and contract at different rates. The mounting plate and metal substrate, attached along the x-y plane, are unable to move independently from one another and thermal stress causes the mounting plate to bend and warp. During further manufacture and testing of the package or carrier sub-assembly, the metal substrate and mounting plate are repeatedly subjected to elevated temperatures. FIG. 1(b) shows that fiber optic assembly 18 when it is moved out of its original position which results in reduced optical coupling between laser light source 12 and the optical fiber. Misalignment of less than one micron can render the optoelectonic package useless.

Attempts have been made to remedy the problems associated with reduced coupling efficiency due to the differential in the expansion/contraction of the metal substrate and mounting plate. For example, optoelectronic packages have been reworked through mechanical or thermal means to restore the coupling efficiency, but only to a limited degree. Other attempts have been made to reduce the thermal stress between the mounting plate and the metal substrate by formulating the metal substrate so that it has a CTE profile that is somewhat similar to the mounting plate. Workable formulations are limited and give rise to other constraints in the metal substrate, such as, a reduction in the heat dissipation of the optoelectronic package.

Accordingly, there is a need for a carrier sub-assembly that has improved heat dissipation while maintaining dimensional stability and minimal warpage during thermal excursions or thermal cycling. It is further desirable to produce a carrier sub-assembly that can be used in an optoelectronic package to achieve and maintain high optical coupling efficiency among the optoelectronic devices while also providing excellent heat dissipation.

### SUMMARY OF THE INVENTION

The present invention provides for a carrier sub-assembly that has improved dimensional stability and yields greater heat dissipation when used in electronic and optoelectronic packages. In one embodiment of the invention the carrier sub-assembly has a metal substrate and one or more inserts, each of which is attached to the metal substrate in a recess of the metal substrate. The insert is made of a material composition which has a thermal conductivity that is less than the thermal conductivity of the metal substrate, but which is more amenable for attachment of electronic and/or optoelectronic devices by, for example, laser spot welding. When the carrier sub-assembly is exposed to thermal fluctuations, the insert expands and contracts in conjunction with the metal substrate, thereby reducing or eliminating warpage.

In another embodiment of the present invention the carrier sub-assembly further comprises a first optoelectronic device mounted an insert and a second optoelectronic device positioned such that the optoelectronic devices are optically coupled. When the carrier sub-assembly is exposed to thermal fluctuations, improved dimensional stability between the metal substrate and the insert results in improved optical alignment and light transmission. When the carrier sub-assembly has multiple inserts for mounting an optoelectronic device, the inserts can have a combined surface area and volume that is less than would be needed to mount the device on a single insert. By reducing the volume of the inserts and increasing the volume of metal substrate, the carrier sub-assembly can provide greater overall heat dissipation and greater design flexibility in accommodating electronic and optoelectronic devices.

### BRIEF DESCRIPTION OF THE DRAWINGS

The present invention may be more readily understood by reference to the following drawings which, however, should not be construed to limit the invention to specific embodiments, and wherein:

FIG. 1(a) is a cross-section horizontal view of a carrier sub-assembly of the prior art used in a conventional laser package;

FIG. 1(b) is a cross-section horizontal view of the laser package of FIG. 1(a) showing misalignment between optoelectronic devices due to thermal mismatch in the carrier sub-assembly;

FIG. 2 is a perspective view illustrating a carrier sub-assembly according to one embodiment of the present invention;

FIG. 3(a) is a perspective view of a carrier sub-assembly showing multiple inserts according to another embodiment of the present invention;

FIG. 3(b) is a perspective view of a carrier sub-assembly showing another placement of the inserts according to another embodiment of the present invention;

FIG. 3(c) is a perspective view of a carrier sub-assembly showing yet another orientation of the inserts according to another embodiment of the invention;

FIG. 4 is a perspective view of a carrier sub-assembly having optoelectronic devices according to another embodiment of the present invention; and

FIG. 5 is a perspective view of an optoelectronic laser package comprising a carrier sub-assembly according to another embodiment of the invention.

### DETAILED DESCRIPTION OF THE INVENTION

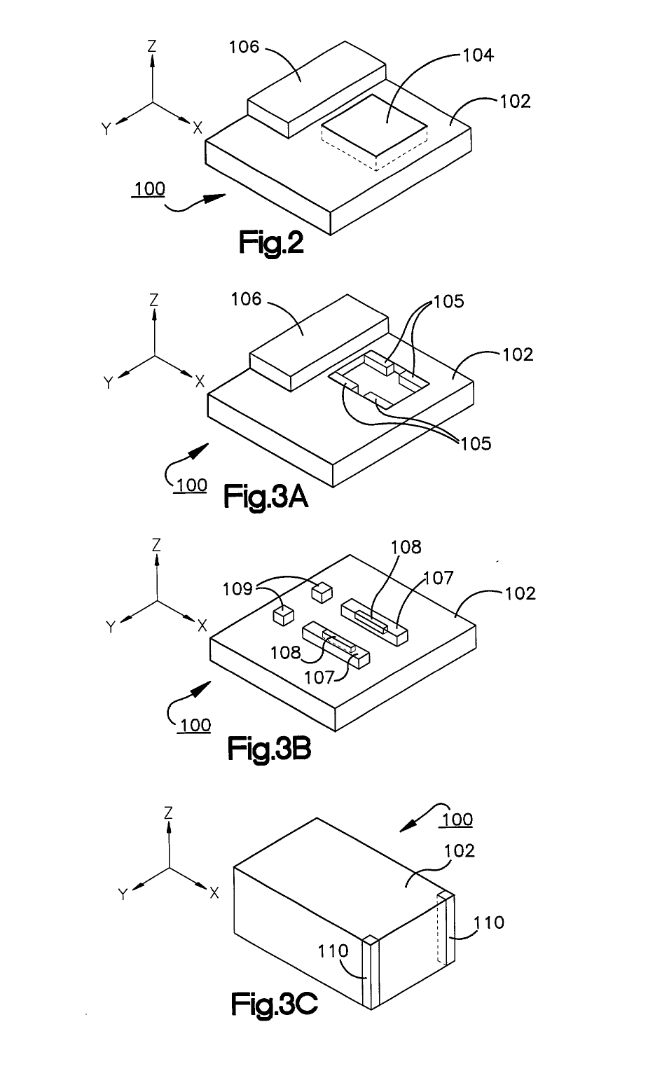

The present invention relates to a carrier sub-assembly, packaging component or package used in the electronic and optoelectronic industries. Referring to FIG. 2 there is shown an exemplary embodiment of carrier sub-assembly 100 of the present invention. In one embodiment of the present invention carrier sub-assembly 100 comprises metal substrate 102 and insert 104. The carrier sub-assembly may be used in a variety of electronic or optoelectronic applications to support heat-generating devices and to quickly dissipate heat that is generated by the devices. The insert is made of a material that is different than the metal substrate to facilitate attachment of devices in applications where direct attachment of an electronic or optoelectronic device to the metal substrate is not practical. The thermal conductivity of the insert, although desirably as high as the metal substrate, is typically different and lower than the thermal conductivity of the metal substrate.

The insert is attached to the metal substrate in a recess of the metal substrate such that at least a portion of the insert is attached to the metal substrate in the three x, y and z dimensions. The metal substrate is machined to produce a recess and the insert is attached to the metal substrate by mechanical or chemical means, for example, by brazing, welding, diffusion bonding, or pressure fit. The metal substrate can be made to have an array of a repeated pattern of metal substrates, or a large metal substrate can be prescribed in an array so that the large metal substrate can be separated (e.g singulated) into several individual metal substrates.

FIG. 2 shows insert 104 flush-mounted relative to metal substrate 102, however, the insert can be countersunk or raised relative to the top surface of the metal substrate. The insert may extend from the top surface to the bottom surface of metal substrate 102 or it may terminate within the metal substrate. The carrier sub-assembly can optionally include submount 106 attached to the metal substrate. The submount can be an integral, raised portion of metal substrate 102 or it may be a separate component having a different material composition and is then attached to the metal substrate by, for example, soldering or brazing.

FIG. 3(a) shows a carrier sub-assembly having multiple inserts 105. The presence of multiple inserts can reduce the total volume of the inserts in the carrier sub-assembly while providing enough surface area to laser spot weld components where needed. The result is an increase in the volume of metal substrate 102 for improved overall heat dissipation and for increased design flexibility in placement of components attached to the metal substrate and inserts. FIG. 3(b) shows metal inserts 108 attached to cavities in pedestals 107 which form a monolithic structure with metal substrate 102. Submounts 109 can also be integral with metal substrate 102 or they can be made of another material and mechanically or chemically attached to the metal substrate. FIG. 3(c) is an alternative embodiment showing inserts 110 attached along the edges of metal substrate 102.

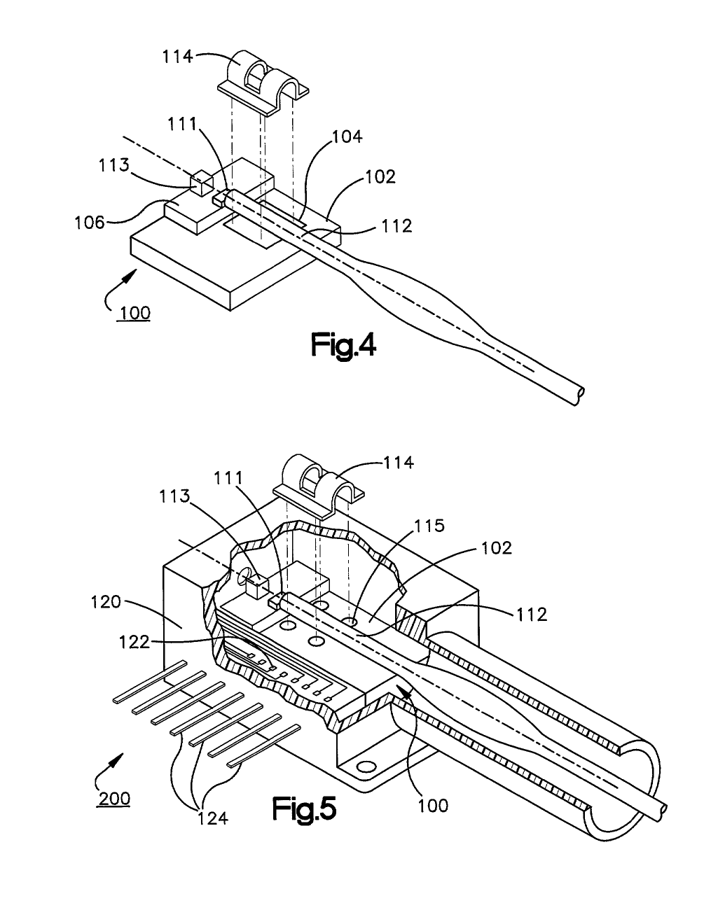

The carrier sub-assembly of the present invention finds application in both electronic and optoelectronic packaging, where an insert is needed to facilitate attachment of a microelectronic device, for example. The insert which is attached to a recess of the metal substrate in the x, y and z dimensions provides dimensional stability to the carrier sub-assembly. FIG. 4 illustrates a carrier sub-assembly having first optoelectronic device 111 which is optically coupled to second optoelectronic device 112. The standards for optical coupling efficiency are dependent upon a particular application, however, the carrier sub-assembly of the present invention results in improved optical coupling, for example about 85% or greater efficiency, between the optoelectronic devices after the carrier sub-assembly is subjected to temperature excursions and temperature cycling during manufacturing and testing.

First optoelectronic device 111 can be a light-emitting device, such as for example, a light source such as a laser or LED (light emitting diode) or a light-receiving device, such as, for example, a receiver device such as a PIN (positive intrinsic device) or ADP (avalanche photo diode). Photo detector 113 can be present to monitor the optical power from the laser. FIG. 4 shows the second optoelectronic device as an optic fiber assembly that is aligned with a laser, but optoelectronic device 112 can be any light-transmitting medium such as, for example, an optical fiber, a lens, a filter or a grating. Second optoelectronic device 112 is shown mounted on insert 104 and secured in place by the attachment of alignment ware 114 onto the insert to maintain optical alignment of the optoelectronic devices. Alignment ware includes, for example, a ring, a U-shaped clip, or any fastener capable of securing the second optoelectronic device in place to maintaining optical coupling. The alignment ware can also be an integral component of the second optoelectronic device, such as for example, legs, tabs or rings. Insert pad 104 can be any size and shape so long as it can accommodate second optoelectronic device 112 and any alignment ware 114 used to secure it in optical alignment.

The metal substrate and the insert have dissimilar material compositions. A suitable material for the metal substrate is a material which is both a good thermal and electrical conductor and which also has low thermal expansion. The metal substrate can be made of a metal matrix composite or a metal alloy or a metal having a thermal conductivity that ranges from about 150 to about 550 W/mK, although typically from about 180 to about 400 W/mK, and a coefficient of thermal expansion that ranges from about 4 to about 8 ppm/° C. and more typically, from about 5.8 to about 7.2 ppm/° C. These materials include, but are not limited to, metal matrix composites such as copper/tungsten, silver/tungsten, copper/molybdenum, aluminum/silicon carbide, beryllium/beryllia, copper/graphite, aluminum/graphite, copper/tungsten diamond, aluminum/aluminum nitride, silver/iron-nickel, for example, silver/Invar™ or Silvar™, silver/iron-nickel-cobalt, for example, Silvar-K™, copper/cubic boron nitride, copper/high conductivity carbon fiber and mixtures thereof, and layered structures such as copper/molybdenum/copper, copper/copper tungsten/copper and mixtures thereof.

Metal matrix composites, in particular, have excellent thermal conductivity because they contain at least two metals in which one is a substantially higher melting refractory metal or reinforcement compound. The metal substrate may be a functionally graded metal substrate (FGM) which has two or more regions of dissimilar materials in the x-y plane of the substrate. A surrounding body region, having a relatively lower coefficient of thermal expansion, constrains a functional insert region of the substrate which has a relatively higher thermal conductivity. FGM substrates are described in U.S. Pat. No. 6,114,048 entitled Functionally Graded Metal Substrates and Process for Making the Same, and is hereby incorporated by reference herein.

A suitable material for the insert is any material that facilitates attachment of the alignment ware or the second optoelectronic device, for example, via laser spot welding. The materials which make up the insert include, but are not limited to, iron-nickel-cobalt alloys, such as for example, Kovar™metals, iron-nickel alloys, such as for example, Invar™ metals, Alloy 42, stainless steel, nickel, and mixtures thereof. Preferred insert materials have a coefficient of thermal expansion that ranges from about 5 to about 6.5 ppm/° C. and is substantially lower than that of the carrier.

The submount can be made of the above metal substrate materials or ceramic materials which include, but are not limited to, aluminum nitride, beryllium oxide, boron nitride and silicon carbide. Ceramics have good thermal conductivity in addition to being good electrical insulators while at the same time provide good thermal expansion match to the semiconductor device.

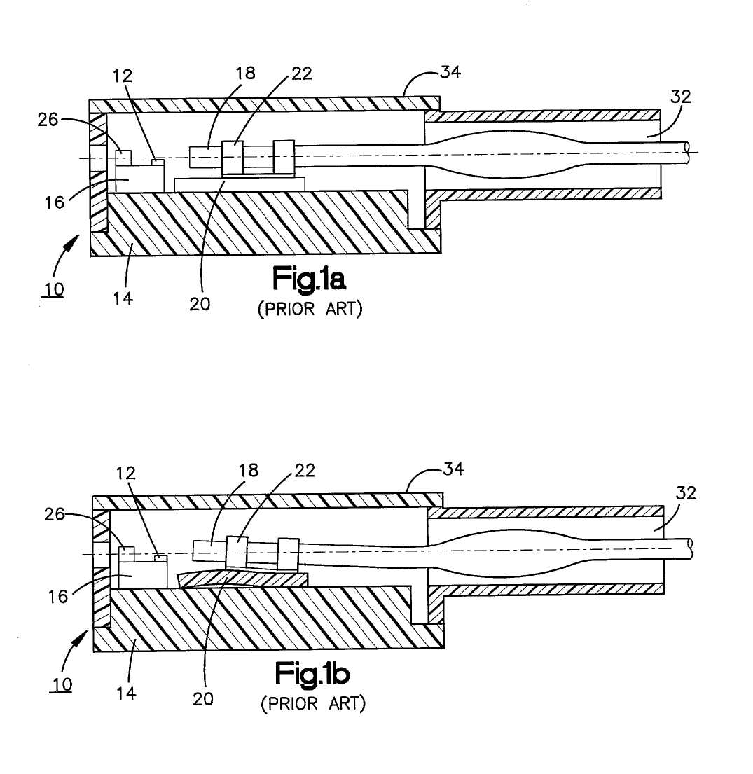

When the carrier sub-assembly is manufactured, it is exposed to varying temperature fluctuations. The insert, which is at least partially attached to the carrier in three dimensions, expands and contracts with the metal substrate, thus providing improved dimensional stability of the carrier sub-assembly. That is, where the thermal stress caused by the differences in the expansion coefficients of the insert and metal substrate materials was applied along a two dimensional, x-y interface in FIG. 1(a), the thermal stress created in the carrier sub-assembly of the present invention is applied along the x-y-z interfaces.

FIG. 5 shows a perspective view of an optoelectronic laser package 200 comprising carrier sub-assembly 100 according to another embodiment of the invention. Optoelectronic packages, such as, for example, lasers, pump laser inserts, tunable lasers, amplifiers, receivers, transmitters, transceivers and electronic packages are often housed in a butterfly package or other metallic package having several leads and optical input and/or output. The combined volume of four inserts 115 embedded within carrier 102 is smaller than the volume of a single insert in FIG. 4 which accommodates the same alignment ware 114. Since less volume of the carrier sub-assembly is consumed by the inserts, the overall heat dissipation of the optoelectronic package can be improved. This can be especially advantageous where optoelectronic device 111, a laser, for example, is located in close proximity to fiber optic assembly 112 that is attached to the insert. Hot spots which would otherwise develop can be eliminated due to the greater volume of the metal substrates. Hot spots can also be alleviated where the metal substrate is a FGM substrate having high thermal conductivity regions in close proximity to the laser. Multiple inserts allow for a more stable temperature distribution across the optical package, and the presence of multiple inserts also compartmentalizes the stress caused by thermal gradients.

Optoelectronic package 200 can also include one or more ceramic metallized pad 122 for wire bonding purposes and to provide additional circuitry support. The ceramic metallized pads can be multi-layer and can contain passive circuitry components such as capacitors, resistors or Lange couplers. Filled conductive vias (not shown) can hermetically connect electrically conductive pattern on metallized pad 122 to the bottom side of carrier. The combination of patterns and filled vias provide an efficient mechanism for hermetically distributing and modulating electrical signals from optical elements inside the package to the periphery of the package.

Although only a few embodiments of the present invention have been described above, it should be appreciated that many modifications can be made without departing from the spirit and scope of the invention. All such modifications are intended to be included within the scope of the present invention, which is to be limited only by the following claims.

We claim:

1. A carrier sub-assembly having improved dimensional stability for use in electronic and optoelectronic industries, the carrier sub-assembly comprising:
a metal substrate having a recess;
an insert attached to the metal substrate in the recess, the insert having a material composition different than the metal substrate;
a first optoelectronic device; and
a second optoelectronic device secured to the insert and optically coupled to the first optoelectronic device.

2. The carrier sub-assembly of claim 1 further comprising:
alignment ware attached to the insert to secure the second optoelectronic device in optical alignment with the first optoelectronic device.

3. The carrier sub-assembly of claim 2 wherein the alignment ware and the insert are made of a material compositions that can be laser spot welded to one another.

4. The carrier sub-assembly of claim 1 wherein the metal substrate has a higher thermal conductivity than the insert.

5. The carrier sub-assembly of claim 1 wherein the metal substrate comprises a metal composition selected from the group consisting of: copper/tungsten, silver/tungsten, copper/molybdenum, aluminum/silicon carbide, beryllium/beryllia, copper/graphite, aluminum/graphite, copper/tungsten diamond, aluminum/aluminum nitride, silver/iron-nickel, silver/Invar™, Silvar™, silver/iron-nickel-cobalt, Silvar-K™, copper/cubic boron nitride, copper/high conductivity carbon fiber, copper/molybdenum/copper, copper/copper tungsten/copper and mixtures thereof.

6. The carrier sub-assembly of claim 1 wherein the insert comprises a metal composition selected from the group consisting of iron-nickel-cobalt alloys, iron-nickel alloys, Alloy 42, stainless steel, nickel, and mixtures thereof.

7. The carrier sub-assembly of claim 2 wherein the alignment ware and the insert are made of an iron-nickel-cobalt alloy.

8. The carrier sub-assembly of claim 1 wherein the first optoelectronic device is a light-emitting device or a light-receiving device and the second optoelectronic device is a light-transmitting medium.

9. The carrier sub-assembly of claim 1 wherein the first optoelectronic device is a light-emitting device that is a laser or a light-emitting diode; and
the light transmitting medium is selected from the group consisting of an optical fiber, a lens, a filter, and a grating.

10. The carrier sub-assembly of claim 1 wherein the first optoelectronic device is a PIN (positive intrinsic device) or ADP (avalanche photo diode); and
the second optoelectronic device is a light transmitting medium selected from the group consisting of an optical fiber, a lens, a filter, and a grating.

11. The carrier sub-assembly of claim 8 wherein:
the first optoelectronic device is a laser; and
and the second optoelectronic device is an optic fiber.

12. The carrier sub-assembly of claim 1 wherein the metal substrate comprises copper/tungsten metal matrix composite and the insert pad comprises iron-nickel-cobalt alloy.

13. The carrier sub-assembly of claim 1 further comprising:
a submount attached to the metal substrate; and
the first optoelectronic device is attached to the submount.

14. The carrier sub-assembly of claim 1 wherein the insert extends from the top surface of the metal substrate and terminates within the metal substrate.

15. The carrier sub-assembly of claim 1 wherein the insert extends from the top surface to the bottom surface of the metal substrate.

16. The carrier sub-assembly of claim 1 wherein the second optoelectronic device is secured to at least two separate inserts attached in one or more recesses of the metal substrate.

17. A carrier sub-assembly having improved dimensional stability for use in the electronic and optoelectronic industries, the carrier sub-assembly comprising:
a metal substrate;
an insert having a material composition that is different than the metal substrate;
a first optoelectronic device that is a light-emitting device or a light-receiving device;
a second optoelectronic device that is a light-transmitting device and is mounted on the insert;
alignment ware that attaches to the insert to achieve optical coupling between the first and second optoelectronic devices; and
the insert is at least partially attached to the metal substrate in three dimensions so that the first and second optoelectronic devices remain optically coupled after having been exposed to temperature excursions;

18. The carrier sub-assembly of claim 17 wherein:
the metal substrate comprises a metal composition selected from the group consisting of: copper/tungsten, silver/tungsten, copper/molybdenum, aluminum/silicon carbide, beryllium/beryllia, copper/graphite, aluminum/graphite, copper/tungsten diamond, aluminum/aluminum nitride, silver/iron-nickel, silver/Invar™, Silvar™, silver/iron-nickel-cobalt, Silvar-K™, copper/cubic boron nitride, copper/high conductivity carbon fiber, copper/molybdenum/copper, copper/copper tungsten/copper and mixtures thereof; and
wherein the insert comprises a metal composition selected from the group consisting of iron-nickel-cobalt alloys, iron-nickel alloys, Alloy 42, stainless steel, nickel, and mixtures thereof.

19. The carrier sub-assembly of claim 18 wherein:
the metal substrate comprises copper/tungsten metal matrix composite and the insert comprises iron-nickel-cobalt alloy.

20. An optoelectronic package comprising:
a housing;
a carrier sub-assembly, the carrier sub-assembly comprising:
a metal substrate;
an insert attached to the metal substrate in a recess of the metal substrate;
a first optoelectronic device;
a second optoelectronic device secured to the insert and optically coupled to the first optoelectronic device; and
wherein the insert is made of a material composition that is different than the metal substrate and enables fixed positioning of the second optoelectronic device during manufacture of the carrier sub-assembly.

21. A method for making a carrier sub-assembly comprising the steps of:
machining a metal substrate to form a recess therein; and
placing an insert into the recess and chemically or mechanically attaching the insert to the metal substrate.

22. The method of claim 20 further comprising:
attaching a first optoelectronic device to a submount on the metal substrate;
optically aligning a second optoelectronic device with the first optoelectronic device; and
laser spot welding alignment ware to the insert to secure second optoelectronic device.
